(19) United States
(12) Patent Application Publication
(10) Pub. No.: US 2023/0214682 A1
(43) Pub. Date: Jul. 6, 2023

(54) SYSTEM, APPARATUS, AND METHOD FOR MAKING A PREDICTION REGARDING A PASSAGE SYSTEM

(71) Applicant: mIQroTech, Inc., State College, PA (US)

(72) Inventors: Meade Lewis, State College, PA (US); James A. Reep, Kingwood, TX (US); Michael G. Kaiser, Lithia, FL (US)

(21) Appl. No.: 17/568,252

(22) Filed: Jan. 4, 2022

(51) Int. Cl. G06N 5/04; G06N 5/02

(52) U.S. Cl. CPC G06N 5/04; G06N 5/022

(57) ABSTRACT

A system for predicting a hazard in a fluid passage system is disclosed. The system has one or more sensor assemblies configured to sense data of the fluid passage system, a prediction module, comprising computer-executable code stored in non-volatile memory, and a machine learning platform including a processor. The one or more sensor assemblies, the prediction module, and the machine learning platform are configured to scan one or more first data storages for events including sensor output of the one or more sensor assemblies, perform processing including preparing data including the sensor output, store the prepared data including the sensor output in one or more second data storages, perform machine learning operations using the prepared data, and produce a prediction of the hazard in the fluid passage system based on the prepared data.

### TECHNICAL FIELD

The present disclosure generally relates to a system, apparatus, and method for making a prediction, and more particularly to a system, apparatus, and method for making a prediction regarding a passage system.

### BACKGROUND

Fluid-carrying structures such as oil pipelines transport fluid (e.g., refined oil or crude oil) over any desired distance (e.g., relatively short distances within industrial facilities and/or relatively long distances of hundreds of miles). Pipelines are typically constructed from structural materials such as steel that may be subject to corrosion and material failure. For example, structural damage and failures are estimated to cost the pipeline industry tens of billions of U.S. dollars each year. Additionally, leaks and spills caused by structural damage and failure of pipelines cause spills that significantly damage the environment.

Varying conventional approaches are used to monitor fluid-carrying structures such as pipelines to attempt to detect potential failures before they occur and cause environmental and financial damage. Such monitoring techniques typically involve significant amounts of data, including sensed data. However, conventional techniques do not provide an efficient and effective technique for making predictions regarding fluid-carrying structures that may help to avoid leaks and spills.

The exemplary disclosed system, apparatus, and method are directed to overcoming one or more of the shortcomings set forth above and/or other deficiencies in existing technology.

### SUMMARY OF THE DISCLOSURE

In one exemplary aspect, the present disclosure is directed to a system for predicting a hazard in a fluid passage system. The system includes one or more sensor assemblies configured to sense data of the fluid passage system, a prediction module, comprising computer-executable code stored in non-volatile memory, and a machine learning platform including a processor. The one or more sensor assemblies, the prediction module, and the machine learning platform are configured to scan one or more first data storages for events including sensor output of the one or more sensor assemblies, perform processing including preparing data including the sensor output, store the prepared data including the sensor output in one or more second data storages, perform machine learning operations using the prepared data, and produce a prediction of the hazard in the fluid passage system based on the prepared data.

In another aspect, the present disclosure is directed to a method. The method includes sensing data of a fluid passage system using one or more sensor assemblies, scanning one or more first data storages for events including sensor output of the one or more sensor assemblies, performing processing including preparing data including the sensor output, storing the prepared data including the sensor output in one or more second data storages, performing machine learning operations using the prepared data, and producing a prediction of a hazard in the fluid passage system based on the prepared data.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 illustrates an exemplary process of the present invention;

FIG. 4 is a schematic illustration of an exemplary computing device, in accordance with at least some exemplary embodiments of the present disclosure; and

FIG. 5 is a schematic illustration of an exemplary network, in accordance with at least some exemplary embodiments of the present disclosure.

### DETAILED DESCRIPTION AND INDUSTRIAL APPLICABILITY

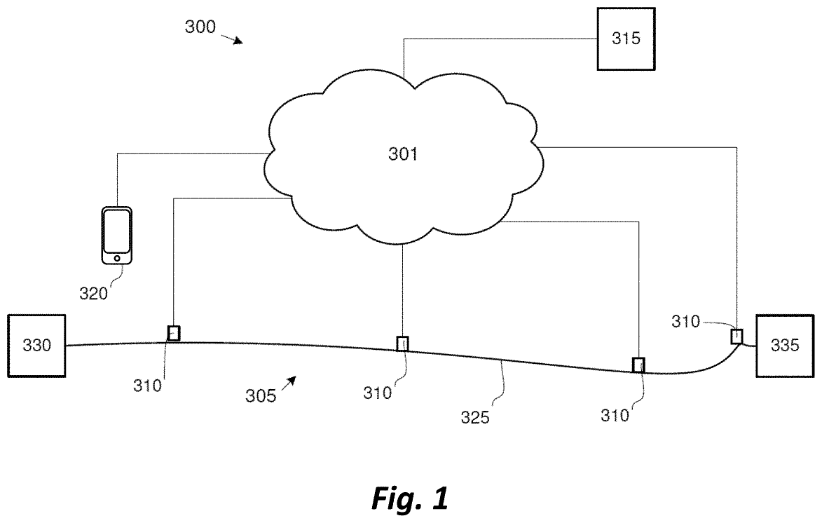

FIG. 1 illustrates an exemplary system 300 for making a prediction regarding a fluid passage system (e.g., a fluid-holding passage system) such as, for example, a passage system 305. For example, system 300 may include any suitable system for monitoring flow in a passage and making a prediction regarding a passage system. For example, system 300 may be used in any application for monitoring and making a prediction regarding flow of material through a passage of a member (e.g., an elongated member). For example, system 300 may be any suitable system for monitoring and making a prediction regarding a flow carried in a passage of a structural member. For example, system 300 may be any suitable system for storage system monitoring and prediction (e.g., when passage system 305 is a fluid-holding structure) or pipeline monitoring and prediction (e.g., when passage system 305 is a pipeline such as, e.g., an oil pipeline, a natural gas pipeline, any pipeline transporting fossil fuels, a water pipeline, a waste or wastewater pipeline, a pipeline transporting oxygen, carbon dioxide, air, chemicals, and/or any other fluid material such as gaseous fluid or liquid fluid material). For example, system 300 may include a sensor assembly that may be a pipeline monitoring assembly (e.g., a refined oil pipeline monitoring assembly or a crude oil pipeline monitoring assembly) configured to be externally attached to a pipeline. Also for example, system 300 may be any suitable system for monitoring and making a prediction regarding a flow of material through a material-transporting passage of a machine, e.g., when passage system 305 may be part of a vehicle (e.g., a motor vehicle, aircraft, and/or ship) and/or industrial or commercial equipment, and/or a structure (e.g., buildings of any size and/or structures such as bridges). For example, system 300 may be any suitable system for predicting an unsuitable operation (e.g., leaking) of a material-transporting passage such as, e.g., a passage transporting a flow of fluid material. For example, system 300 may be any suitable system for monitoring and making a prediction regarding a flow of any suitable material through a passage. Further for example, system 300 may be any suitable system for monitoring and making a prediction regarding corrosion and/or any other desired parameters of a fluid storage assembly or reservoir (e.g., an oil storage tank or reservoir, a gaseous and/or liquid gas storage tank or reservoir, and/or any other suitable tank or reservoir of any desired size for storing or carrying a gaseous, liquid, and/or solid material).

Passage system 305 may be any suitable system that transports a flow material such as, for example, gaseous fluid material, liquid fluid material, and/or solid material (e.g., solid material capable of acting in a fluid-like manner). Passage system 305 may include any suitable fluid-holding structure such as, for example, a passage for carrying fluid (e.g., a pipeline) and/or a structure for holding fluid (e.g., a reservoir or a tank). As illustrated in FIG. 1, passage system 305 may include a plurality of members 325. For example, members 325 may be any suitable structural member for transporting flow material, e.g., a structural member including a passage. For example, member 325 may be a structural piping member having a passage (e.g., any suitable substantially hollow passage or channel). For example, member 325 may be a structural metal (e.g., steel) pipe, a structural plastic (e.g., PVC) pipe, and/or a structural member formed from any suitable material for forming a passage for transporting flow material. Member 325 may have any suitable shape for transporting flow material such as, for example, a circular or elliptical shape, a square or rectangular shape, a polygonal shape, and/or any other suitable shape. Also for example, member 325 may be any suitable member for transporting a flow of material through exemplary vehicles, equipment, and/or structures disclosed, e.g., above. For example, member 325 may also be a relatively thin metal tubing (e.g., copper tubing) such as a passage for transporting fluid through a vehicle (e.g., fuel, hydraulic fluid, and/or coolant), industrial equipment, and/or a structure. Also for example, member 325 may be any suitable reservoir or tank for holding any desired gaseous fluid material, liquid fluid material, and/or solid material. For example, member 325 may be a petroleum (e.g., oil) or gas storage tank or any other desired tank or reservoir for storing a desired material.

The exemplary disclosed flow material may be any suitable material that may be transported via members 325. For example, the flow material may be a fluid material (e.g., gaseous fluid material and/or liquid fluid material), a solid material capable of acting in a fluid-like manner (e.g., a granular material such as fine aggregate such as sand and/or coarse aggregate such as stones that may be mixed with water or other fluid), and/or a combination of any suitable gaseous fluid, liquid fluid, and/or fluid-like solid material. For example, the flow material may be a fossil fuel in fluid form (e.g., refined oil or crude oil, natural gas, and/or any other suitable type of fossil fuel), water, air, oxygen, carbon dioxide, any suitable chemical in fluid form, waste or wastewater, and/or any other suitable material that may flow through a passage.

The exemplary disclosed flow material may be, for example, transported under pressure through members 325 of passage system 305. For example, a plurality of members 325 may be attached together and placed above and/or underground to transfer flow material over any suitable distance (e.g., members 325 may be attached together by fasteners, welding, and/or any other suitable technique to form passage system 305). For example, passage system 305 may transport flow material (e.g., under pressure) between a plurality of locations. For example as illustrated in FIG. 1, passage system 305 may transport flow material between a first location 330 and a second location 335. For example, locations 330 and 335 may be one or more of an industrial activity (e.g., refinery, chemical production facility, drilling platform or location, and/or any other suitable industrial facility), commercial activity utilizing flow material (e.g., a factory or other production facility, an airport, a city, a port, and or any other suitable commercial activity), multiple locations in a vehicle utilizing flow material, and/or multiple locations in the same structure or in different structures. For example, locations 330 and 335 may be located at any suitable distance from each other such as, e.g., tens or hundreds of feet (e.g., different points or locations in the same vehicle, structure, and or facility), thousands of feet (e.g., points or locations in differing vehicles, structures, and/or facilities), and/or several miles, dozens of miles, hundreds of miles, and/or thousands of miles from each other (e.g., pipelines transporting flow material over relatively long distances).

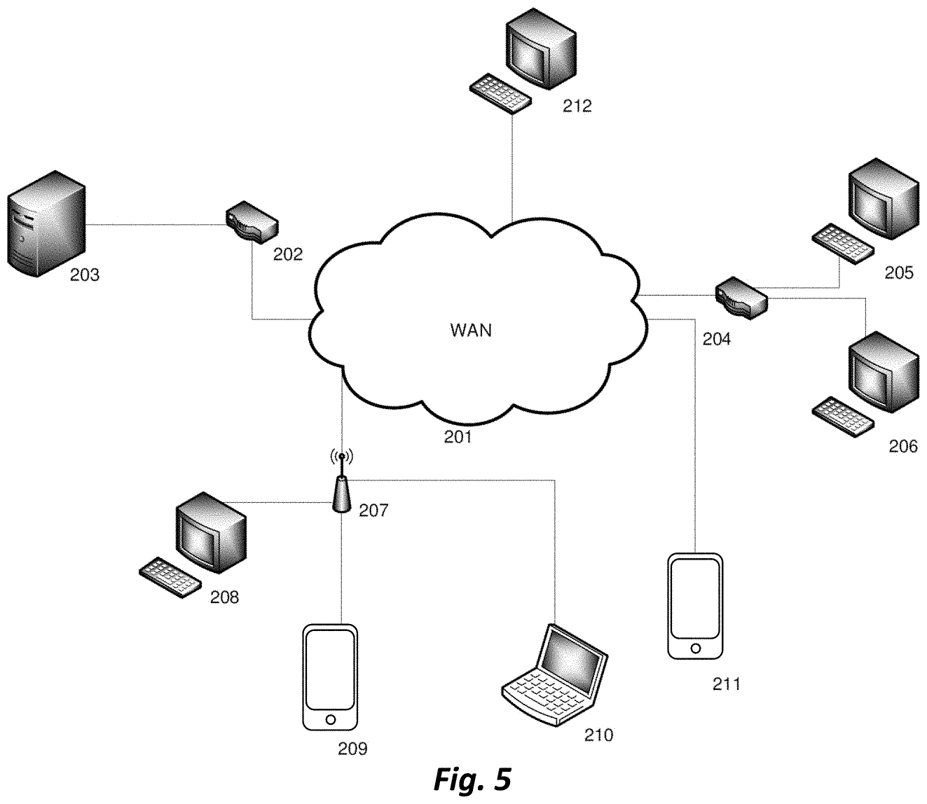

As illustrated in FIG. 1, system 300 may include a sensor assembly 310, a prediction module 315, and a user interface 320. For example, system 300 may include a plurality of sensor assemblies 310. Sensor assembly 310, prediction module 315, and user interface 320 may be connected for example via a network 301, which may be similar to exemplary network 201 disclosed below regarding FIG. 5.

Sensor assembly 310 may communicate data to any other suitable component of system 300. For example, sensor assembly 310 may include any suitable transceiver device (e.g., transmitter device and/or receiver device) for transmitting data sensed by sensors of sensor assembly 310 to other components of system 300 (e.g., to prediction module 315 via network 301) and also for receiving data from other components of system 300. For example, sensor assembly 310 may receive and transmit data as disclosed below regarding exemplary communication techniques of FIG. 5. For example, sensor assembly 310 may wirelessly transmit data by any suitable technique such as, e.g., wirelessly transmitting data via 4G LTE networks or 5G networks (e.g., and/or any other suitable data transmission technique for example via network 301). For example, sensor assembly 310 may transmit data collected by sensors of sensor assembly 310 substantially continuously or at any desired interval (e.g., up to 20 times per second and/or up to 50 times per second or more). For example, sensed data may be wirelessly transmitted from sensor assembly 310 (e.g., to other components of system 300) between about 40 and 45 times per second, for example, up to about 42 times per second.

Sensor assembly 310 may for example include a controller for controlling an operation of sensors of a sensor array and a communication device of sensor assembly 310. The controller may include for example a micro-processing logic control device or board components. Also for example, the controller may include input/output arrangements that allow it to be connected (e.g., via wireless and/or electrical connection) to sensors and a communication device of sensor assembly 310, prediction module 315, and/or user interface 320 (e.g., via network 301 and/or via direct communication). For example, the controller may control an operation of sensor assembly 310 based on input received from prediction module 315 and/or user interface 320 and may control a transmission of output from the sensors of sensor assembly 310. For example, the controller may communicate with components of system 300 via wireless communication and/or via electrical lines (e.g., electrical line communication to sensors and/or a communication device of sensor assembly 310). For example, the controller may control sensors and/or the communication device of sensor assembly 310 so that sensor assembly 310 acts as an Internet of Things (IoT) device that may provide data to and/or be controlled by system 300 as a data-providing device.

Sensors of sensor assembly 310 may collect data associated with a flow of flow material through passages of members 325. Sensors of sensor assembly 310 may include any suitable sensors for measuring any suitable properties associated with flow material, a flow of flow material, and/or properties of portions of passage system 305. For example, sensors of sensor assembly 310 may include a vibration sensor, a location sensor, a pressure sensor, a density sensor, a corrosion sensor, a temperature sensor, and/or any other suitable type of sensor for measuring properties of flow material and/or portions of passage system 305. Also for example, sensors of sensor assembly 310 may include a sonic boom detection sensor. For example, sensors of sensor assembly 310 may include any suitable sensor for detecting a sonic boom (e.g., a sonic boom caused by jets, rifles, and/or lightning) that may for example cause valves of passage system 305 to malfunction or operate unsuitably.

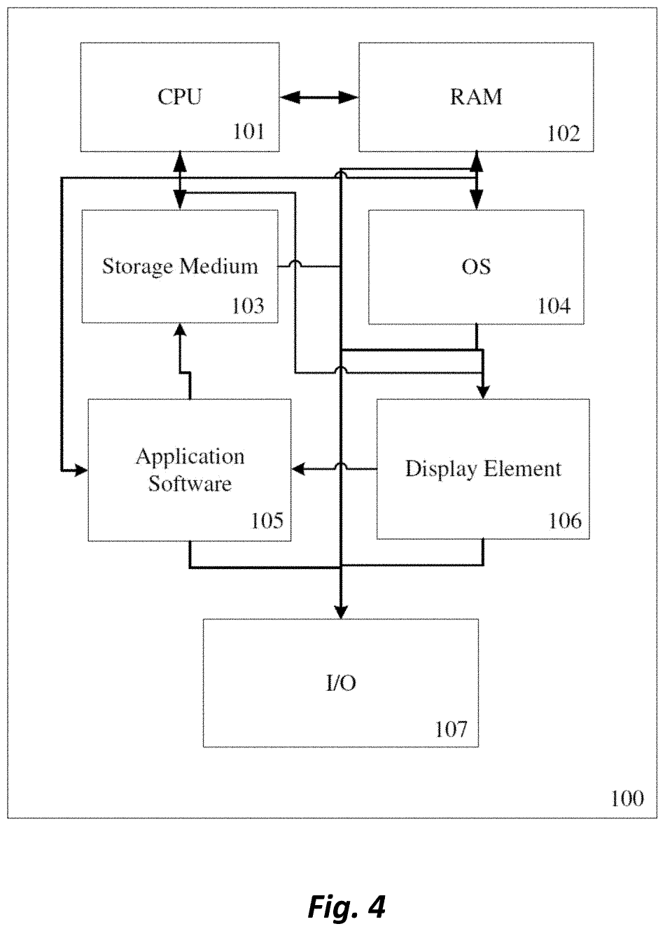

Returning to FIG. 1, prediction module 315 may communicate with other components of system 300 via network 301 (e.g., as disclosed below regarding FIG. 5). Prediction module 315 may also be partially or substantially entirely integrated with one or more components of system 300 such as, for example, network 301, user interface 320, and/or one or more sensor assemblies 310. Prediction module 315 may include components similar to the exemplary components disclosed below regarding FIGS. 4 and 5. For example, prediction module 315 may include computer-executable code stored in non-volatile memory. Prediction module 315 may also include a processor, or alternatively, a processor for processing data associated with system 300 may be partially or substantially entirely integrated into any portion (e.g., or combination of portions) of system 300 (e.g., network 301, prediction module 315, user interface 320, and/or one or more sensor assemblies 310).

Prediction module 315 may be configured to retrieve, store, process, and/or analyze data transmitted from one or more sensor assemblies 310 to prediction module 315. For example, prediction module 315 may operate using data from any desired number or sensor assemblies 310 such as, for example, one, two, several, dozens, hundreds, and/or thousands or more sensor assemblies 310 (including, e.g., vibration data, location data, pressure data, density data, corrosion data, temperature data, and/or any other suitable data describing any other desired properties of flow material and/or portions of passage system 305).

Prediction module 315 may perform analysis using the data received from sensor assemblies 310 to for example predict potential failure, leaks, and/or other unsuitable operation of passage system 305 before such unsuitable operation may occur. For example, prediction module 315 may utilize sophisticated machine learning and/or artificial intelligence techniques to perform predictive analysis using some or substantially all data collected by sensor assemblies 310. For example, system 300 (e.g., prediction module 315) may for example utilize the collected data to prepare and submit (e.g., via network 301, for example via wireless transmission such as via 4G LTE or 5G networks) datasets and variables to cloud computing clusters and/or other analytical tools (e.g., predictive analytical tools) which may analyze such data using artificial intelligence neural networks. Prediction module 315 may for example include cloud computing clusters performing predictive analysis. For example, prediction module 315 may utilize neural network-based artificial intelligence to predictively assess risk (e.g., potential failure of portions of passage system 305 based on continuously collected data transmitted from sensor assemblies 310). For example, system 300 (e.g., prediction module 315) may use the collected data to predict a longevity of operation of some or all portions of passage system 305. For example, the exemplary neural network may include a plurality of input nodes that may be interconnected and/or networked with a plurality of additional and/or other processing nodes to determine a predicted result. For example, exemplary neural networks of system 300 may determine a predicted result of a given portion of passage system 305 to be one of the following exemplary predicted results: “no problem” or “all clear” (e.g., no failure or unsuitable operation predicted during a predetermined time period), a soft alert such as a warning (e.g., no imminent danger of failure, but indications of possible future unsuitable operation exist), and/or an urgent warning (e.g., imminent failure or unsuitable operation is predicted).

For example, exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, exemplary artificial intelligence processes may also include processing for training a machine learning model to predict a longevity of passage system 305 (e.g., including potential failures of passage system 305) based on data collected by sensor assemblies 310. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to predict a longevity of passage system 305 (e.g., including potential failures of passage system 305) based on data collected by sensor assemblies 310.

For example, exemplary artificial intelligence processes of system 300 may include using data (e.g., such as density data of flow material measured by a density sensor of sensor assembly 310) collected by one or more sensor assemblies 310 to identify air pockets, cavitation, a presence of debris, and/or a flow direction within a passage of passage system 305. Also for example, exemplary artificial intelligence processes of system 300 may include using data (e.g., such as corrosion data measured by a corrosion sensor of sensor assembly 310) collected by one or more sensor assemblies 310 to identify a rate at which members 325 may be corroding. Further for example, exemplary artificial intelligence processes of system 300 may include using data (e.g., such as pressure data measured by a pressure sensor of sensor assembly 310) collected by one or more sensor assemblies 310 to measure pressure differences between different sensor assemblies 310 to predict potential locations of unsuitable operation of passage system 305. Additionally for example, exemplary artificial intelligence processes of system 300 may include using data (e.g., such as vibration data measured by a vibration sensor of sensor assembly 310) collected by one or more sensor assemblies 310 to identify potential leaks and/or deteriorating portions of passage system 305 that may fail. Also for example, exemplary artificial intelligence processes of system 300 may include using data (e.g., such as location data measured by a location sensor of sensor assembly 310) collected by one or more sensor assemblies 310 to pinpoint and prioritize competing locations of potential future unsuitable operation (e.g., identify and prioritize locations of passage system 305 to be remediated to avoid future failure). Further for example, exemplary artificial intelligence processes of system 300 may include using data (e.g., such as temperature data measured by a temperature sensor of sensor assembly 310) collected by one or more sensor assemblies 310 to predict potential areas of failure by identifying portions of passage system 305 having abnormal temperatures and/or experiencing unsuitable expansion and/or contraction. For example, system 300 may provide predicted results for some or all monitored portions of passage system 305 such as the exemplary results disclosed above (e.g., “no problem” or “all clear,” soft alerts such as a warning, and/or urgent warnings). For example, if a given sensor assembly 310 provides data indicating a large increase in vibration of a given member 325 (e.g., as sensed by a vibration sensor of sensor assembly 310) occurring contemporaneously or nearly contemporaneously with a sharp decrease of sensed pressure at that location (e.g., based on sensed data provided by a pressure sensor and a location sensor of sensor assembly 310), system 300 may issue an urgent warning indicating currently-occurring and/or imminent member failure and leakage (e.g., oil spill). System 300 may make predictions and issue warnings based on any suitable combination of sensed data and/or changes in sensed data that may indicate any given number of potential scenarios. For example, a large increase in temperature of flow material at a given location as sensed by a temperature sensor and a location sensor of sensor assembly 310 may indicate a likelihood of undesired combustion and an urgent warning may be issued. Also for example, less significant swings or changes in collected data may result in system 300 issuing a warning (e.g., “soft alert”). System 300 may operate (e.g., using artificial intelligence) to issue any suitable number of possible predictive results based on any suitable combination of collected data and/or changes in collected data.

For example, system 300 (e.g., prediction module 315) may utilize continuously collected data from sensor assemblies 310, which may include thousands, millions, and/or billions of data points, to perform predictive analysis using artificial intelligence and/or machine learning. System 300 (e.g., prediction module 315) may for example use the continuously-growing body of data collected by sensor assemblies 310 to establish benchmarks and metrics for defining a suitable range of operation of passage system 305 (e.g., that can be used in conjunction with other similar exemplary passage systems to benchmark suitable operation, and/or which may be used as a comparison against data indicating an unsuitable operation). For example, system 300 (e.g., prediction module 315) may use substantially all available data to continuously refine predictive analysis for identifying potential failure and/or unsuitable operation of passage system 305. System 300 (e.g., prediction module 315) may use the above exemplary disclosed data along with the additional data for example as described below in making predictions regarding an unsuitable operation of passage system 300 for example as described below.

User interface 320 may be any suitable user interface for receiving input and/or providing output (e.g., raw data and/or results of predictive analysis described above) to a user. User interface 320 may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 4 and 5). For example, user interface 320 may include a touchscreen device of a smartphone or handheld tablet. For example, user interface 320 may include a display (e.g., a computing device display, a touchscreen display, and/or any other suitable type of display) that may provide raw data and/or predictive analysis results to a user. For example, the display may include a graphical user interface to facilitate entry of input by a user and/or receiving output. For example, a user may utilize user interface 320 to query raw data results and/or enter parameters to define a set of desired output (e.g., portions of passage system 305 that are most likely to fail within a specified time period such as, for example, the next 30 days, the next 6 months, the next year, the next several years, and/or the next decade or longer time period). Also for example, system 300 may provide alerts to a user via output transmitted to user interface 320 (e.g., alerts pushed to a user via user interface 320) for example if a portion of passage system 305 is predicted to imminently fail and/or if significant, sudden changes occur regarding collected data (e.g., one or more sensor assemblies 310 report a large increase or decrease in values that may indicate a significant probability of failure such as, for example, a sharp drop in measured pressure by a pressure sensor of sensor assembly 310). System 300 may also send such alerts by alternative methods such as, for example, via text message, email, and/or recording sent by telephone. User interface 320 may for example provide a graphical user interface to a user.

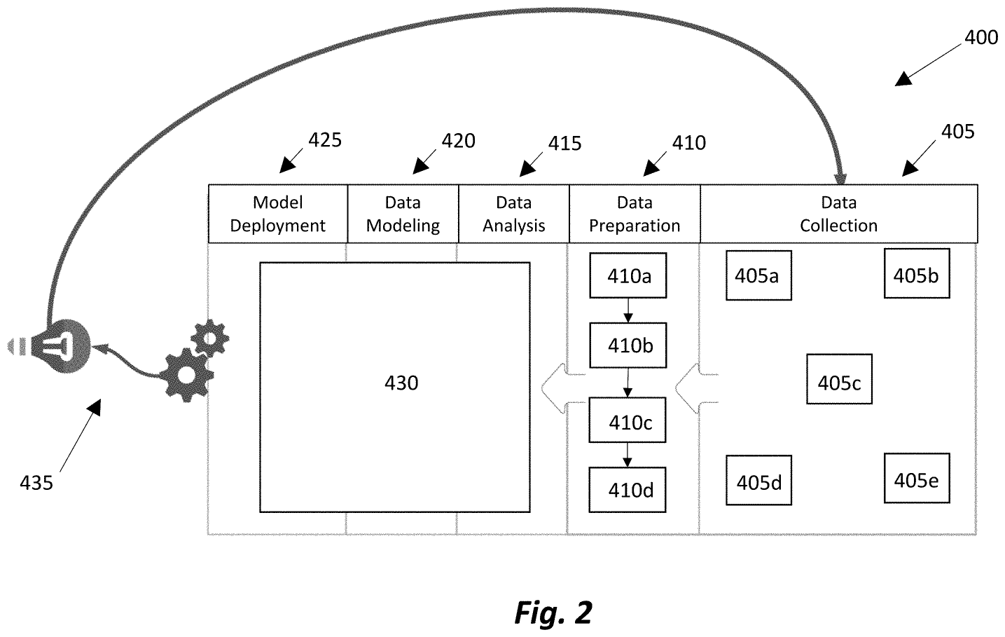

The exemplary disclosed machine learning operations for predicting unsuitable operation of passage system 305 such as hazards (e.g., a spill or leak) performed using prediction module 315 may be based on any suitable data from any suitable data source. Such data may include the exemplary disclosed sensed data (e.g., sensed and transferred from sensor assemblies 310) described above. The data may also include any suitable data source for example as illustrated in FIG. 2.

FIG. 2 schematically illustrates an exemplary disclosed data flow 400 of at least some exemplary embodiments of the exemplary disclosed system, apparatus and method (e.g., performed using prediction module 315). Data flow 400 may include processes such as data collection 405, data preparation 410, data analysis 415, data modeling 420, and model deployment 425.

Data collection 405 may be a process performed by system 300 (e.g., performed using prediction module 315) that may include collecting data from any suitable data sources such as, for example, one or more document-oriented databases 405a, one or more relational databases 405b, one or more object storages 405c, one or more data lakes 405d, and/or one or more external databases 405e. One or more data sources of data collection 405 may include combinations of the exemplary disclosed data sources. The exemplary disclosed sensed data (e.g., sensed and transferred from sensor assemblies 310) described above may be included in any of document-oriented databases 405a, relational databases 405b, object storages 405c, data lakes 405d, and/or external databases 405e. For example, sensor assemblies 310 may transfer data (e.g., via network 301) to any of document-oriented databases 405a, relational databases 405b, object storages 405c, data lakes 405d, and/or external databases 405e, which may then be utilized during an operation of prediction module 315. Any other suitable data may be included in any of document-oriented databases 405a, relational databases 405b, object storages 405c, data lakes 405d, and/or external databases 405e such as, for example, proprietary oil and gas industry data sources, government databases such as transportation agency data, mining industry databases, financial analytic data such as Wall Street analyst data, national intelligence data, and/or any other suitable data associated with systems and structures such as passage system 305.

Document-oriented databases 405a, relational databases 405b, object storages 405c, data lakes 405d, and/or external databases 405e may be partially and/or substantially entirely integrated with any suitable component of system 300 such as, for example, network 301, user interfaces 320, and/or sensor assemblies 310. In at least some exemplary embodiments, document-oriented databases 405a, relational databases 405b, object storages 405c, data lakes 405d, and/or external databases 405e may be part of on-demand cloud computing platforms. For example, document-oriented databases 405a, relational databases 405b, object storages 405c, data lakes 405d, and/or external databases 405e may be part of one or more virtual clusters of computers that may for example be located at a server farm (e.g., via Amazon web services or any other similar service provider). Document-oriented databases 405a, relational databases 405b, object storages 405c, data lakes 405d, and/or external databases 405e may also be integrated into physical hardware components of system 300 (e.g., similar to the exemplary disclosed components described regarding FIG. 4). The data of document-oriented databases 405a, relational databases 405b, object storages 405c, data lakes 405d, and/or external databases 405e may be integrated into any suitable components internal and/or external to system 300 that may be accessed by prediction module 315 and utilized during an operation of prediction module 315.

Document-oriented database 405a may be an SQL database. For example, document-oriented database 405a may be any suitable database that supports document and/or key-value data structures. Document-oriented database 405a may be a document-oriented and/or a key-value database. In at least some exemplary embodiments, document-oriented database 405a may include a Redis database, an Amazon DynamoDB database, a MongoDB database, and/or any other suitable database.

Relational database 405b may be any suitable relational database. Relational database 405b may also be an SQL database. In at least some exemplary embodiments, relational database 405b may include an Amazon RDS database, a MySQL® database, an Oracle Database, and/or any other suitable database.

Object storage 405c may be any suitable storage for storing data such as an object. Object storage 405c may store unstructured data as objects. In at least some exemplary embodiments, object storage 405c may include an Azure Blob storage, an Amazon S3 storage, a DigitalOcean® object storage, and/or any other suitable storage.

Data lake 405d may be any suitable repository for storing data in a raw or natural format. Data lake 405d may store data as files, blobs, and/or any other suitable form. Data lake 405d may also provide for any suitable formatting of data stored in data lake 405d. Data lake 405d may be a secure data lake. In at least some exemplary embodiments, data lake 405d may include a Snowflake data lake, a Yellowbrick data lake, an AWS Lake Formation, and/or any other suitable data lake.

External database 405e may include any suitable database, storage, data lake, or other suitable data-storing component that may be located external to system 300 and that may be accessed and utilized by system 300 (e.g., by prediction module 315). External database 405e may include components that may be similar to document-oriented database 405a, relational database 405b, object storage 405c, and/or data lake 405d.

Document-oriented database 405a, relational database 405b, object storage 405c, data lake 405d, and/or external database 405e may include ingested data that may be configured for use by system 300 during data preparation 410. For example, one or more document-oriented databases 405a, relational databases 405b, object storages 405c, data lakes 405d, and/or external databases 405e may include data that may be configured (e.g., ready) to be extracted, transformed, and/or loaded during the step of data preparation 410.

Data preparation 410 may be a process performed by system 300 (e.g., performed using prediction module 315) that may include processes performed by and/or including a scanning platform 410a, a computing platform 410b, a file 410c, and an object storage 410d. Object storage 410d may be similar to object storage 405c.

Scanning platform 410a may be any suitable event-driven computing platform for running computer code. Scanning platform 410a may run computer code in response to events such as user actions, sensor outputs (e.g., of sensor assemblies 310), message passing, and/or any other suitable events. Scanning platform 410a may scan other components of system 300 during operation such as document-oriented databases 405a, relational databases 405b, object storages 405c, data lakes 405d, and/or external databases 405e. For example, scanning platform 410a may run computer code in response to events of document-oriented databases 405a, relational databases 405b, object storages 405c, data lakes 405d, and/or external databases 405e. In at least some exemplary embodiments, scanning platform 410a may be an AWS Glue platform, an Azure Data Factory platform, an Apache Airflow platform, and/or any other suitable scanning platform.

Computing platform 410b may be any suitable event-driven computing platform that may react to any suitable event. Computing platform 410b may operate in a hyper-ready state that may allow computing platform 410b to react in real-time or near real-time to events. Computing platform 410b may react to events such as website clicks, sensor readings (e.g., of sensor assemblies 310), and/or data uploads to document-oriented databases 405a, relational databases 405b, object storages 405c, data lakes 405d, and/or external databases 405e. In at least some exemplary embodiments, computing platform 410b may be an Azure Automation platform, an AWS Lambda platform, a Google Cloud Functions platform, and/or any other suitable computing platform.

File 410c may be any suitable file for organizing data records and data fields. In at least some exemplary embodiments, file 410c may be a comma-separated value (CSV) file having multiple lines forming data records, with each data record including one or more data fields separated by commas. File 410C may be any other suitable file for organizing data such as, for example, Parquet files, XML files, JSON files, and/or any other suitable data files.

System 300 may include a machine learning platform 430 for performing steps of data flow 400 based on an operation of prediction module 315. Machine learning platform 430 may be any suitable platform for performing the exemplary disclosed machine learning operations described herein. Machine learning platform 430 may create, train, and deploy a machine learning model based on an operation of prediction module 315. Machine learning platform 430 may perform any suitable data analysis (e.g., data analysis 415), data modeling (e.g., data modeling 420), and model deployment (e.g., model deployment 425). Machine learning platform 430 may include any suitable libraries for machine learning such as a symbolic mathematical library based on differentiable programming and/or data flow. For example, machine learning platform 430 may include one or more libraries such as TensorFlow, PyTorch, Scikit-learn, and/or any other suitable library. In at least some exemplary embodiments, machine learning platform 430 may be an Amazon SageMaker platform, an Azure Machine Learning platform, an IBM Watson platform, and/or any other suitable computing platform. Machine learning platform 430 may operate to produce a prediction 435. Prediction 435 may be a prediction of unsuitable operation (e.g., a hazard such as a leak or spill of passage system 305) for example as described herein.

The exemplary disclosed system, apparatus, and method may be used in any suitable application for fluid-carrying structures. For example, the exemplary disclosed apparatus, system, and method may be used in any suitable application involving material flowing through a passage of a member. For example, the exemplary disclosed apparatus, system, and method may be used for pipelines (e.g., an oil pipeline or a chemical pipeline), material-transporting passages of a machine such as a vehicle (e.g., a motor vehicle, aircraft, and/or ship) and/or industrial or commercial equipment, and/or flow through passages of a structure (e.g., buildings of any size and/or structures such as bridges). For example, the exemplary disclosed apparatus, system, and method may be used in any suitable application for making predictions regarding unsuitable operation (e.g., leaking) of a material-transporting passage such as, e.g., a passage carrying a flow of fluid.

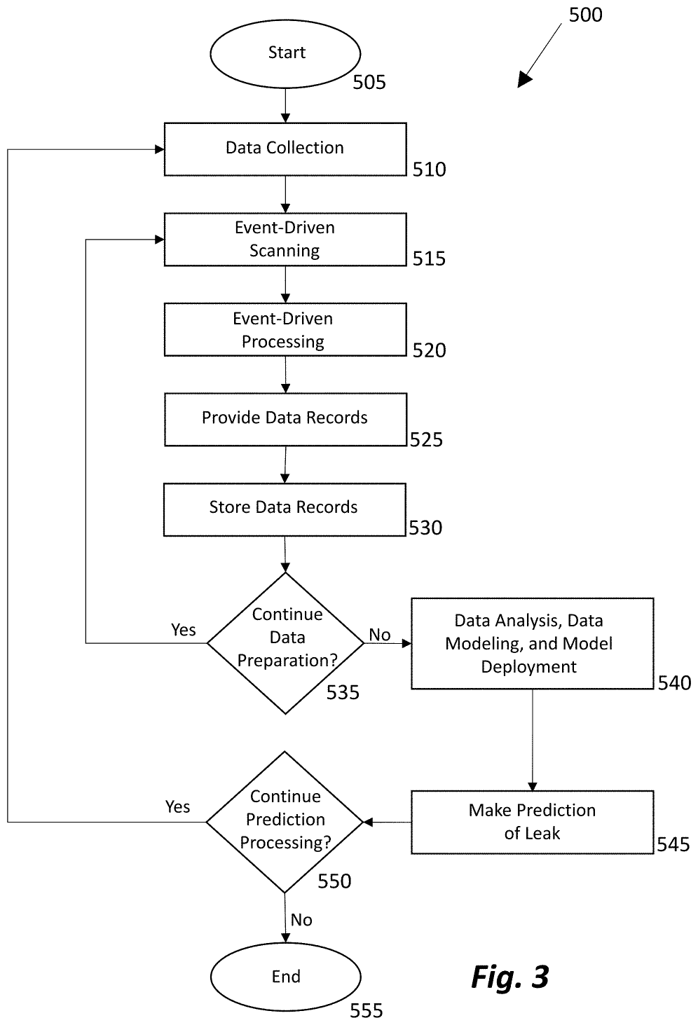

An exemplary operation of the exemplary disclosed system, apparatus, and method will now be described. For example, FIG. 3 illustrates an exemplary process 500. Process 500 starts at step 505. At step 510, system 300 (e.g., including prediction module 315) may operate to perform data collection. For example, system 300 may collect data from one or more document-oriented databases 405a, relational databases 405b, object storages 405c, data lakes 405d, and/or external databases 405e. The collected data may include data sensed and transferred from sensor assemblies 310 as well as any other suitable data for example as described herein.

At step 515, system 300 (e.g., including prediction module 315) may perform event-driven scanning. For example, scanning platform 410a may scan document-oriented databases 405a, relational databases 405b, object storages 405c, data lakes 405d, and/or external databases 405e, and run computer code in response to events of document-oriented databases 405a, relational databases 405b, object storages 405c, data lakes 405d, and/or external databases 405e. For example, scanning platform 410a may run computer code in response to sensor outputs (e.g., of sensor assemblies 310) and/or any other suitable events for example as described herein.

At step 520, system 300 (e.g., including prediction module 315) may perform event-driven processing. For example, computing platform 410b may react to (e.g., run computer code in response to) events associated with document-oriented databases 405a, relational databases 405b, object storages 405c, data lakes 405d, and/or external databases 405e. For example, computing platform 410b may react in real-time or near real-time to sensor outputs (e.g., of sensor assemblies 310) and/or any other suitable events for example as described herein.

At step 525, system 300 (e.g., including prediction module 315) may provide data records. For example, system 300 (e.g., including prediction module 315) may utilize files 410c to format data processed by scanning platform 410a and/or computing platform 410b. For example, data processed by scanning platform 410a and/or computing platform 410b may be formatted as comma-separated value files and/or any other suitable file type using files 410c for example as described herein.

At step 530, system 300 (e.g., including prediction module 315) may store data records. For example, system 300 (e.g., including prediction module 315) may store files 410c including formatted data processed by scanning platform 410a and/or computing platform 410b in object storage 410d or any other suitable storage or database for example as described herein.

At step 535, system 300 (e.g., including prediction module 315) may determine whether or not to continue data preparation based on any suitable criteria such as, for example, machine learning operations and/or predetermined algorithms of prediction module 315, any suitable event for example as described herein, user input, and/or any other suitable criteria. If data preparation is to be continued, process 500 may return to step 515, and steps 515 through 535 may be repeated for any desired number of iterations. If data preparation is not to be continued, process 500 may proceed to step 540.

At step 540, system 300 (e.g., machine learning platform 430 operating with prediction module 315) may create, train, and deploy a machine learning model, including performing any suitable data analysis (e.g., data analysis 415), data modeling (e.g., data modeling 420), and model deployment (e.g., model deployment 425). Machine learning platform 430 may operate with prediction module 315 to prepare prediction 435.

At step 545, machine learning platform 430 may make prediction 435 for example as described herein. Prediction 435 may be a prediction of unsuitable operation (e.g., a hazard such as a leak or spill of passage system 305) for example as described herein. Prediction 435 may be based on sensed data of sensor assemblies 310 that may be utilized for example as described above regarding data flow 400 and process 500. For example, machine learning platform 430 may operate with prediction module 315 to provide prediction 435 based on any suitable data or criteria for example as described herein.

At step 550, system 300 (e.g., including machine learning platform operating with prediction module 315) may determine whether or not to continue prediction processing based on any suitable criteria such as, for example, machine learning operations and/or predetermined algorithms of prediction module 315, any suitable event for example as described herein, user input, and/or any other suitable criteria. If prediction processing is to be continued, process 500 may return to step 510, and steps 510 through 550 may be repeated for any desired number of iterations. If prediction processing is not to be continued, process 500 may end at step 555.

In at least some exemplary embodiments, the exemplary disclosed system may be a system for predicting a hazard in a fluid passage system, including one or more sensor assemblies (e.g., sensor assembly 310) configured to sense data of the fluid passage system, a prediction module (e.g., prediction module 315), comprising computer-executable code stored in non-volatile memory, and a machine learning platform including a processor. The one or more sensor assemblies, the prediction module, and the machine learning platform may be configured to scan one or more first data storages for events including sensor output of the one or more sensor assemblies, perform processing including preparing data including the sensor output, store the prepared data including the sensor output in one or more second data storages, perform machine learning operations using the prepared data, and produce a prediction of the hazard in the fluid passage system based on the prepared data. The fluid passage system may be an oil or gas pipeline system. The prediction of the hazard may be a leak or a spill of the oil or gas pipeline. The one or more first data storages may include at least one selected from the group of a proprietary oil and gas industry data source, a government agency database, a mining industry database, financial analytic data, and combinations thereof. Scanning the one or more first data storages may include using an event-driven computing platform to identify a plurality of events. The plurality of events may include the sensor output stored in an object storage, a relational database, or a data lake of the one or more first data storages. The event-driven computing platform may be a cloud computing platform. The event-driven computing platform may be an Amazon AWS Glue platform. Performing processing including preparing data may include the machine learning platform reacting to the sensor output in real-time. Performing processing including preparing data may include using an Amazon AWS Lambda platform. The one or more second data storages may include a cloud-based Amazon S3 storage.

In at least some exemplary embodiments, the exemplary disclosed method may include sensing data of a fluid passage system using one or more sensor assemblies (e.g., sensor assembly 310), scanning one or more first data storages for events including sensor output of the one or more sensor assemblies, performing processing including preparing data including the sensor output, storing the prepared data including the sensor output in one or more second data storages, performing machine learning operations using the prepared data, and producing a prediction of a hazard in the fluid passage system based on the prepared data. The fluid passage system may be an oil or gas pipeline system and the prediction of the hazard is a leak or a spill of the oil or gas pipeline. The one or more first data storages may include at least one selected from the group of a document-oriented database, a relational database, an object storage, a data lake, an external database, and combinations thereof. The one or more first data storages may include a document-oriented database, a relational database, an object storage, a data lake, and an external database. The one or more sensor assemblies may include at least one sensor selected from the group of a vibration sensor, a location sensor, a pressure sensor, a density sensor, a corrosion sensor, a temperature sensor, and combinations thereof.

In at least some exemplary embodiments, the exemplary disclosed system may be a system for predicting a leak or a spill in an oil or gas pipeline, including one or more sensor assemblies (e.g., sensor assembly 310) configured to sense data of the oil or gas pipeline, a cloud-based prediction module (e.g., prediction module 315), comprising computer-executable code stored in non-volatile memory, and a cloud-based machine learning platform including a processor. The one or more sensor assemblies, the cloud-based prediction module, and the cloud-based machine learning platform may be configured to scan one or more first data storages for events including sensor output of the one or more sensor assemblies, perform processing including preparing data including the sensor output, store the prepared data including the sensor output in one or more second data storages, perform machine learning operations using the prepared data, and produce a prediction of the leak or the spill in the oil or gas pipeline based on the prepared data. The one or more first data storages and the one or more second data storages may be cloud-based storages. The one or more first data storages may include at least one selected from the group of an Amazon DynamoDB database, an Amazon RDS database, an Amazon S3 storage, an Amazon AWS Lake Formation, and combinations thereof. The one or more sensor assemblies may include at least one sensor selected from the group of a vibration sensor, a location sensor, a pressure sensor, a density sensor, a corrosion sensor, a temperature sensor, and combinations thereof.

The exemplary disclosed system, apparatus, and method may provide an efficient and effective technique for making predictions regarding a fluid passage system. For example, the exemplary disclosed system, apparatus, and method may provide predictions that may help to avoid leaks and spills. The exemplary disclosed system, apparatus, and method may leverage data associated with the oil and gas industry to avoid damage to the environment and waste of natural resources.

An illustrative representation of a computing device appropriate for use with embodiments of the system of the present disclosure is shown in FIG. 4. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 5, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 5, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 5, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed apparatus, system, and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A system for predicting a hazard in a fluid passage system, comprising:
one or more sensor assemblies configured to sense data of the fluid passage system;
a prediction module, comprising computer-executable code stored in non-volatile memory; and
a machine learning platform including a processor;
wherein the one or more sensor assemblies, the prediction module, and the machine learning platform are configured to:
scan one or more first data storages for events including sensor output of the one or more sensor assemblies;
perform processing including preparing data including the sensor output;
store the prepared data including the sensor output in one or more second data storages;
perform machine learning operations using the prepared data; and
produce a prediction of the hazard in the fluid passage system based on the prepared data.

2. The system of claim 1, wherein the fluid passage system is an oil or gas pipeline system.

3. The system of claim 2, wherein the prediction of the hazard is a leak or a spill of the oil or gas pipeline.

4. The system of claim 1, wherein the one or more first data storages includes at least one selected from the group of a proprietary oil and gas industry data source, a government agency database, a mining industry database, financial analytic data, and combinations thereof.

5. The system of claim 1, wherein scanning the one or more first data storages includes using an event-driven computing platform to identify a plurality of events.

6. The system of claim 5, wherein the plurality of events includes the sensor output stored in an object storage, a relational database, or a data lake of the one or more first data storages.

7. The system of claim 5, wherein the event-driven computing platform is a cloud computing platform.

8. The system of claim 5, wherein the event-driven computing platform is an Amazon AWS Glue platform.

9. The system of claim 1, wherein performing processing including preparing data includes the machine learning platform reacting to the sensor output in real-time.

10. The system of claim 1, wherein performing processing including preparing data includes using an Amazon AWS Lambda platform.

11. The system of claim 1, wherein the one or more second data storages includes a cloud-based Amazon S3 storage.

12. A method, comprising:
sensing data of a fluid passage system using one or more sensor assemblies;
scanning one or more first data storages for events including sensor output of the one or more sensor assemblies;
performing processing including preparing data including the sensor output;
storing the prepared data including the sensor output in one or more second data storages;
performing machine learning operations using the prepared data; and
producing a prediction of a hazard in the fluid passage system based on the prepared data.

13. The method of claim 12, wherein the fluid passage system is an oil or gas pipeline system and the prediction of the hazard is a leak or a spill of the oil or gas pipeline.

14. The method of claim 12, wherein the one or more first data storages includes at least one selected from the group of a document-oriented database, a relational database, an object storage, a data lake, an external database, and combinations thereof.

15. The method of claim 12, wherein the one or more first data storages includes a document-oriented database, a relational database, an object storage, a data lake, and an external database.

16. The method of claim 12, wherein the one or more sensor assemblies includes at least one sensor selected from the group of a vibration sensor, a location sensor, a pressure sensor, a density sensor, a corrosion sensor, a temperature sensor, and combinations thereof.

17. A system for predicting a leak or a spill in an oil or gas pipeline, comprising:
one or more sensor assemblies configured to sense data of the oil or gas pipeline;
a cloud-based prediction module, comprising computer-executable code stored in non-volatile memory; and
a cloud-based machine learning platform including a processor;
wherein the one or more sensor assemblies, the cloud-based prediction module, and the cloud-based machine learning platform are configured to:
scan one or more first data storages for events including sensor output of the one or more sensor assemblies;
perform processing including preparing data including the sensor output;
store the prepared data including the sensor output in one or more second data storages;
perform machine learning operations using the prepared data; and
produce a prediction of the leak or the spill in the oil or gas pipeline based on the prepared data.

18. The system of claim 17, wherein the one or more first data storages and the one or more second data storages are cloud-based storages.

19. The system of claim 17, wherein the one or more first data storages includes at least one selected from the group of an Amazon DynamoDB database, an Amazon RDS database, an Amazon S3 storage, an Amazon AWS Lake Formation, and combinations thereof.

20. The system of claim 17, wherein the one or more sensor assemblies includes at least one sensor selected from the group of a vibration sensor, a location sensor, a pressure sensor, a density sensor, a corrosion sensor, a temperature sensor, and combinations thereof.
